(19) United States
(12) Patent Application Publication
(10) Pub. No.: US 2026/0355040 A1
(43) Pub. Date: Nov. 12, 2026

(54) MOBILE HAND EXOSKELETON FOR SUPPORT AND REHABILITATION

(71) Applicants: BURSA ULUDAG ÜNIVERSITESI, Nilüfer, Bursa (TR); MYGENE SAGLIK HIZMETLERI ARGE SANAYI VE TICARET LIMITED SIRKETI, Nilüfer, Bursa (TR)

(72) Inventors: Ismail Emir YASSI, Izmit, Kocaeli (TR); Sehime Gülsün TEMEL, Nilüfer, Bursa (TR)

(21) Appl. No.: 19/127,972

(22) PCT Filed: Nov. 22, 2022
(86) PCT No.: PCT/TR2022/051333

§ 371 Date: May 7, 2025

(30) Foreign Application Priority Data
Nov. 11, 2022 (TR) 2022/017072

(51) Int. Cl. A61H 1/02

(52) U.S. Cl. CPC A61H 1/0288; A61H 2201/123; A61H 2201/1638; A61H 2201/5007; A61H 2230/605

(57) ABSTRACT

Disclosed is a wearable mobile hand exoskeleton that can be used by patients with various movement disorders in their daily life activities and in a clinical setting. The mobile hand exoskeleton will be used to actively support and rehabilitatively benefit the grasping and opening functions of the hand and various compensatory movements in patients in whom adequate improvement cannot be achieved in conventional physical therapy and rehabilitation programs.

### TECHNICAL FIELD

The invention relates to a wearable mobile hand exoskeleton that patients with various movement disorders can use in their activities of daily living and in a clinical setting.

### PRIOR ART

Existing mobile hand exoskeletons are basically divided into two categories: rigid and soft. Rigid exoskeletons are far from being suitable for the anatomical structure of each hand with their rough structure, and they are also heavy and cause difficulty in adapting the patients to the device. Soft exoskeletons, which solve this problem and adapt better to human anatomy, have difficulty in providing sufficient force for the grasping function. To overcome this challenge, the electronics and actuation systems of soft exoskeletons need to be incorporated into stronger, larger, more space-consuming and burdensome units that need to be worn on other parts of the body in addition to the hand exoskeleton, creating an additional burden and difficulty for users.

In addition, existing systems are often not suitable for biofeedback, a method of accelerating rehabilitation. Those that are suitable only allow for one type of biofeedback.

One of the problems with existing soft hand exoskeletons is that the free movement of the wrist can result in inadequate force transmission and biosignals that command the skeleton to work can be inadvertently generated, biosensors can be inadvertently activated, false activation signals can reach the system and this can adversely affect the patient's ability to use the device effectively.

One of the most important aspects of any medical/rehabilitative application is patient accessibility. The prices of existing exoskeletons, which are inaccessible for most patients, cause these individuals to be unable to access the necessary treatment and force support.

In the patent application document numbered EP3226824B1 in the prior art, a hand rehabilitation device is mentioned. The device does not have features such as providing movement with a ring system connected to each other with a wearable flexible material, being in one piece and can be worn in one go, having an interface integrated into the device that gives commands and notifications to the patient and where the system can be controlled, keeping the wrist stable and preventing artifact signals and insufficient force transfer, providing visual and kinetic and auditory biofeedback, and having the components that provide these integrated into the system. For these reasons, the device described in patent application document EP3226824B1 differs from the mobile hand exoskeleton subject to this description.

As a result, due to the inadequacy of the solutions to meet the needs described above, it has become necessary to make a development in the relevant technical field.

### PURPOSE OF THE INVENTION

The invention aims to solve the above-mentioned drawbacks by being inspired by existing situations.

The purpose of the invention is to provide a wearable mobile hand exoskeleton that can be used by patients with various movement disorders in their daily life activities and in a clinical setting.

The structural and characteristic features and all the advantages of the invention will be more clearly understood by means of the figures given below and the detailed description written with reference to these figures, and therefore the evaluation should be made by taking these figures and detailed description into consideration.

### BRIEF DESCRIPTION OF THE FIGURES

FIG. 1 is a rear view of the inventive mobile hand exoskeleton.

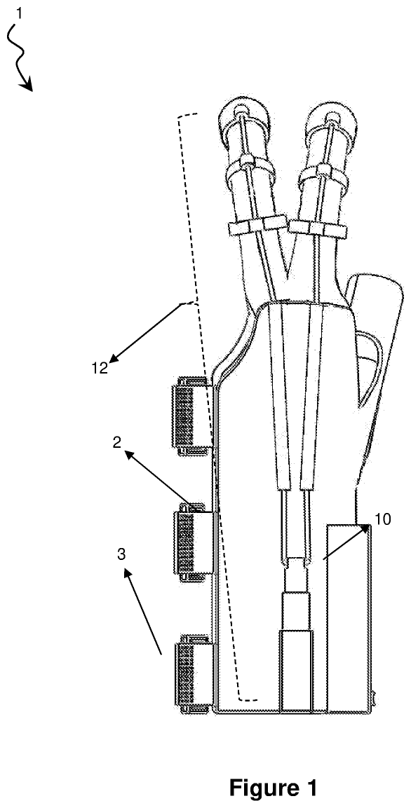

FIG. 2 is a front view of the inventive mobile hand exoskeleton.

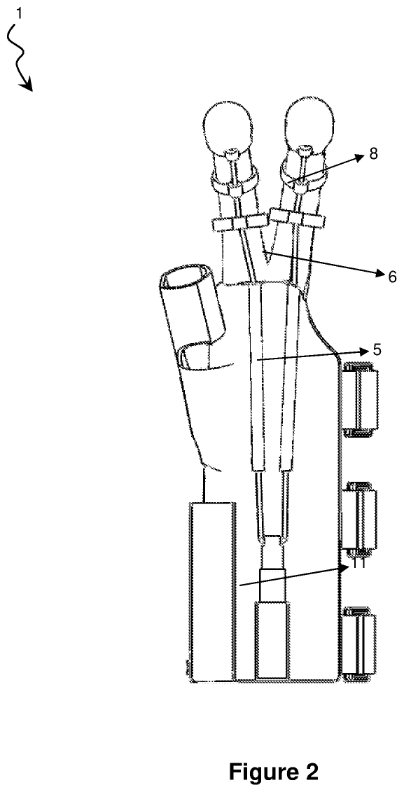

FIG. 3 is a side view of the inventive mobile hand exoskeleton.

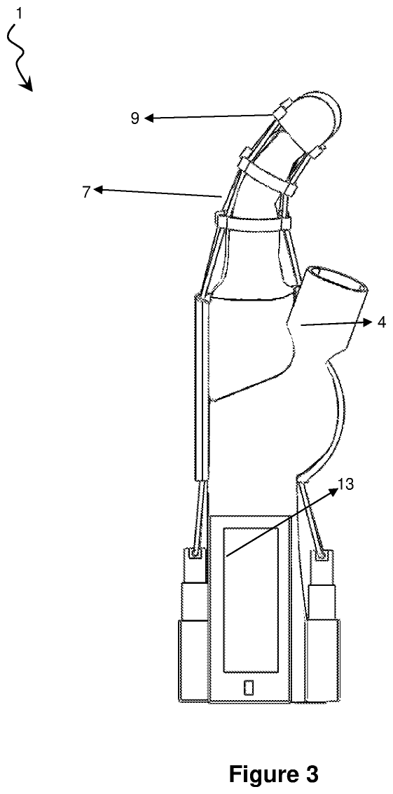

### DESCRIPTION OF PART REFERENCES

1. Mobile hand exoskeleton
2. Body
3. Band
4. Thumb support
5. Mobilizer
6. Channel
7. Flexible material
8. Ring
9. Capped rings
10. Electronic control unit
11. Actuator
12. Driver
13. Display

### DETAILED DESCRIPTION OF THE INVENTION

In this detailed description, preferred embodiments of the inventive mobile hand exoskeleton (1) are described only for the purpose of a better understanding of the subject matter.

The invention relates to a wearable mobile hand exoskeleton (1) that can be used by patients with various movement disorders in their daily life activities and in a clinical setting. The mobile hand exoskeleton (1) will be used to actively support and rehabilitatively benefit the grasping and opening functions of the hand and various compensatory movements in patients in whom adequate improvement cannot be achieved in conventional physical therapy and rehabilitation programs.

Mobile hand exoskeleton (1) includes;
a wearable body (2) that has flexible and rigid supports, has a structure that can be worn easily, ensures that the wrist remains stable as it has rigid support on the wrist part and thus prevents the formation of false biosignals, facilitates force transfer and also has all components integrated on it,
a band (3) that allows the body (2) to be adjusted according to the patient's hand and wrist thanks to its adjustable structure,
a thumb support (4) that allows the thumb to remain fixed in the grasping position, thereby reducing the number of fingers that need to move, reducing mechanical complications and allowing the size of the required electronic devices to be reduced,
mobilizers (5) made of biomimetic rope and rope-shaped material (e.g., steel) that mimic the tendons of the hand, which provide anatomical movement of the fingers in the pulled direction when pulled,
channels (6) that allow the mobilizers (5) to move on the body (2) in line with the anatomy,
rings (8) that have channels (6) around them for the passage of mobilizers (5) and are connected to each other by a wearable flexible material (7) (e.g. elastane) and can be manufactured by additive manufacturing from flexible material (7), allowing users with different sized fingers to use the device,
capped rings (9) made of flexible material (7) with additive manufacturing, which includes a non-slip at the end to keep the rings (8) fixed without slipping, allowing the patient with mobility impairment to hold the object more stably thanks to its non-slip structure,
an electronic control unit (10) that transmits the signal received by the surface electromyography sensor to the microcontroller and sends a hand closing command when the microcontroller understands that the user wants to close the hand thanks to the appropriate classification software, sends a hand opening signal by working in the opposite direction when the user wants to open the hand, and can also give compensatory movement commands for various movement disorders thanks to its changeable functions, the main components inside are a microcontroller, a surface electromyography sensor, a battery, and audio devices that can transmit back the biosignals collected from the user in the form of biofeedback, with a start button and indicators that can be easily accessed by the user, and easy access as it is located on the part of the wrist facing the patient,
a miniature linear actuator (11) that works according to the electromyography signal, activated by the muscle signal received through the surface electromyography sensor in the electronic control unit (10) and the command of the microcontroller, pulls the mobilizers (5) through the channels (6) in the body (2) and through the channels (6) in the rings (8) and capped rings (9), which are interconnected with the wearable flexible material (7), and provides the closure of the fingers and provides sufficient force while doing so,
a driver (12) consisting of a linear actuator (11), mobilizers (5), channels (6), rings (8) and capped rings (9) connected to each other with a wearable and flexible material (7), which is a mechanism that provides movement, eliminates the need for an external actuator unit and increases mobility thanks to its compact and lightweight structure and ability to provide sufficient power, provides mechanical support and haptic and kinetic biofeedback by acting according to the user's real-time request, and
an integrated display (13) that commands the user, enables the user to perform control and command operations, processes the biosignal from the user with software and filtering, and provides visual biofeedback to the user

The driver (12) and electronic control unit (10) used in the mobile hand exoskeleton (1) are miniaturized. In this way, the driver (12) and the electronic control unit (10) are located in the wearable part of the mobile hand exoskeleton (1) and integrated into the system without taking up space/weight. Keeping the thumb fixed in the grasping position and moving only the index and middle finger provides sufficient function for functions such as grasping and fine grasping in daily life. Reducing the amount of moving fingers prevents mechanical complications and allows miniaturized electronics to provide sufficient power.

The mobile hand exoskeleton (1) consists of both rigid and flexible/soft parts. The mobile hand exoskeleton (1) consists of rigid supports to stabilize the wrist and wearable soft parts to better fit the hand. Some parts of the invention, such as the rings (8) and the capped rings (9), are made of flexible material with an additive manufacturing model, which enables these rings (8) and capped rings (9) to be easily customized to the patient, to be accessible/affordable, to be simple to manufacture, and for the mobile hand exoskeleton (1) to be easily accessible to the patient.

The electronic control unit (10) processes the biosignal from the user with software and filtering, and provides real-time auditory biofeedback to the user through its audio devices. The electronic control unit (10) also provides visual biofeedback to the user via the display (13). The system, which moves according to the patient's real-time request, also provides haptic and kinetic biofeedback through this paired movement. In this way, rehabilitation is accelerated. Thus, roughly; the rehabilitation process is accelerated by inducing neuroplasticity by making the user feel, see and hear the biosignals collected from the user in real time.

Individuals with mobility impairment, especially those who are unable to close their hand, adjust the body (2) made of wearable soft and rigid materials with the help of adjustable bands (3) and wear it together with rings (8) and a capped ring (9), which are already interconnected with the wearable flexible material (7). The mobile hand exoskeleton (1), which starts to work when the electronic control unit (10) presses the start button, determines some operating parameters such as threshold value and safety interval with the surface electromyography signal thanks to the calibration software. When these parameters are met, the microcontroller transmits the command to close the hand to the driver (12), which is the actuation mechanism. The miniature linear actuator (11), located on the palm side, pulls the mobilizer (5) consisting of the attached ropes and similar materials through the channels (6) in the body (2). The mobilizer (5), which also passes through the channels (6) in the rings (8) and capped rings (9), closes the fingers in accordance with the anatomy of the hand by means of the rings (8) and finally the capped rings (9). When the surface electromyography signal falls below certain parameters such as threshold value and safety interval, the system works in the opposite way and the driver (12) located on the back of the hand opens the hand and the object is released. The mobile hand exoskeleton (1) can be used to open the hand of patients who cannot open their hand as a result of change of function or for various movement disorders thanks to the compensatory movements it can produce for these movement disorders. The driver (12) mimics the muscles in the flexor and extensor compartments of the hand and the tendons of these muscles that reach the fingers. Thanks to the thumb support (4), objects that the person may need in daily life activities can be held between the thumb, which is already in a fixed grip position, and the index and middle finger, which are moved.

1. A wearable mobile hand exoskeleton that can be used by patients with various movement disorders in their daily life activities and in the clinical environment, the mobile hand exoskeleton comprising:
a wearable body having rigid supports to support and stabilize the wrist and soft parts to adapt to the hand, and which facilitates force transfer and also has all components physically and functionally integrated on the wearable body;
an electronic control unit, that the main components of which are a microcontroller, a surface electromyography sensor, a battery and audio devices that can transmit back biosignals collected from the user in the form of biofeedback, and has a start button and indicators that are accessed by the user, that transmits the signal received by the surface electromyography sensor, which is located at the electronic control unit, which is located on the part of the wrist facing the patient, to the microcontroller and sends a hand closure command when the microcontroller understands that the user wants to close the hand thanks to classification software, sends a hand opening signal by working in the opposite direction when the user wants to open the hand, and can also give compensatory movement commands for various movement disorders thanks to its changeable functions;
a driver comprising a linear actuator, mobilizers, channels, rings and capped rings connected to each other with a flexible and wearable material, which is a mechanism that provides movement, provides mechanical support and haptic and kinetic biofeedback by acting according to the user's real-time request; and
an integrated display that transmits the biosignal from the user back to the user as biofeedback through the control unit.

2. The mobile hand exoskeleton according to claim 1, wherein the wearable body comprises a band which, thanks to body's adjustable structure, enables the wearable body to be adjusted in accordance with the hand and wrist of the user.

3. The mobile hand exoskeleton according to claim 1, comprising a thumb support that allows the thumb to remain fixed in the grasping position, thereby reducing mechanical complications by reducing the number of fingers that need to be moved and allowing the size of the required electronic devices to be reduced.

4. The mobile hand exoskeleton according to claim 1, wherein the mobilizers are made of biomimetic rope and rope-shaped material imitating the tendons of the hand, which provide anatomical movement of the fingers in the pulled direction.

5. The mobile hand exoskeleton according to claim 1, wherein the mobilizers comprise channels enabling the mobilizers to move on the wearable body in line with the anatomy.

6. The mobile hand exoskeleton according to claim 1, wherein the rings have channels around them for the passage of the mobilizers and connected to each other by the wearable flexible material and enabling users with fingers of different sizes to use the device since rings can be produced by additive manufacturing from flexible material.

7. The mobile hand exoskeleton according to claim 1, wherein the capped rings are made of flexible material with additive manufacturing, which includes a non-slip at the end for the rings to remain fixed without slipping, which enables the patient with mobility impairment to hold the object more stably thanks to its non-slip structure.

8. The mobile hand exoskeleton according to claim 1, comprising miniature linear actuators which are activated by the muscle signal received through the surface electromyography sensor in the electronic control unit and the command of the microcontroller, which act according to the electromyography signal, which pull the mobilizers through the channels in the wearable body and through the channels in the rings and capped rings, which are connected to each other with the wearable flexible material, and which enable the fingers to be closed and provide sufficient force while doing so.
